(19) United States
(12) Patent Application Publication
(10) Pub. No.: US 2021/0339269 A1
(43) Pub. Date: Nov. 4, 2021

(54) PERSONAL PROTECTIVE APPARATUS WITH MESH SHIELD

(71) Applicant: Carl Kuntz, Waterloo (CA)

(72) Inventor: Carl Kuntz, Waterloo (CA)

(21) Appl. No.: 17/190,558

(22) Filed: Mar. 3, 2021

Related U.S. Application Data
(60) Provisional application No. 63/017,346, filed on Apr. 29, 2020.

(51) Int. Cl. B03C 3/155; B01D 46/00; B01D 46/42; B03C 3/011; B03C 3/38; B03C 3/66; A42B 1/0195; A41D 19/00; A41D 31/30; A41D 31/14; A41D 13/11; A62B 7/10; A62B 18/04

(52) U.S. Cl. CPC B03C 3/155; A62B 23/02; B01D 46/4245; B03C 3/011; B03C 3/38; B03C 3/66; A42B 1/0195; A41D 19/0006; A41D 31/305; A41D 31/145; A41D 13/1192; A62B 7/10; A62B 18/04; B01D 2279/65; A41D 13/1184; B01D 46/0028

(57) ABSTRACT

A personal protective apparatus, having a wearable support member and a mesh shield securable thereto. The mesh shield may include first and second air-permeable conductive layers secured to the wearable support member and a first air-permeable non-conductive layer received between the first and second air-permeable conductive layers to separate them, and a portable power supply coupled to the mesh shield with a negative high voltage lead to the first air-permeable conductive layer and a positive high voltage lead to the second air-permeable conductive layer. The mesh shield may be a flexible mesh shield, and include at least one air-permeable layer secured at a first layer upper end to the wearable support member to hang from the wearable support member, the at least one air-permeable layer including at least one of an anti-virus material and an anti-microbial material. A fibrous filter layer may overlay an outer surface of the mesh shield.

### RELATED APPLICATIONS

This application claims priority to U.S. Provisional Patent Application Ser. No. 63/017,346, filed Apr. 29, 2020 entitled “Personal Protective Apparatus with Mesh Shield”, the entire contents of which are hereby incorporated by reference herein for all purposes.

### FIELD

The specification relates to apparatus for protecting humans from harmful microorganisms, and in particular, to personal protective equipment such as face and hand shields.

### BACKGROUND

Personal protective equipment is used in a wide variety of applications to protect human beings from harmful microorganisms such as infectious bacteria and viruses. For example, much personal protective equipment is intended to stop viruses and bacteria from entering a person's body so that the person does not need to deal with the viruses and bacteria after then have entered the person's body and begin to replicate.

Face masks may be used as protective coverings to protect a user's respiratory system and prevent the entry of microorganisms. Such masks often include filters, and are commonly worn by persons who are in polluted environments in an effort to protect themselves from inhaling airborne contaminants. Filter masks typically have a fibrous or sorbent filter that is capable of removing particulate and/or gaseous contaminants from the air. For example, a face mask may include a woven or non-woven fibrous filter made of fiberglass, paper, polyester, or cotton fibers (e.g., a HEPA filter including a mat of randomly arranged fiberglass fibers or a surgical mask including a melt-blown polymer layer), which may or may not include electrostatic charges.

In some cases, face masks that include filters may be worn to protect from pathogens such as viruses and bacteria. However, filter masks may not provide sufficient protection from pathogens. In some cases, pathogens may pass through a filter mask. In some cases, pathogens may settle on a filter mask and be reintroduced to air when the filter mask is disturbed. Further, many filter masks are difficult to use and may be hard to wear or hard to breathe easily through, especially for an extended period of time (e.g., many consecutive hours, as may be required for hospital workers).

There is accordingly a need for improved personal protective apparatus.

### SUMMARY

The following summary is intended to introduce the reader to various aspects of the applicant's teaching, but not to define any invention.

According to some aspects, there is provided a personal protective apparatus, comprising a wearable support member; a mesh shield securable to the wearable support member, the mesh shield being shaped for shielding a portion of a user's body, the mesh shield comprising a first air-permeable conductive mesh layer made of an electrically conductive mesh material, a second air-permeable conductive mesh layer made of an electrically conductive material, and a first air-permeable non-conductive mesh layer made of a non-conductive material, received between the first and second air-permeable conductive layers to separate the first and second air-permeable conductive layers; and a portable power supply coupled to the mesh shield with a negative voltage lead connected to the first air-permeable conductive mesh layer and a positive voltage lead connected to the second air-permeable conductive mesh layer.

In some examples, the mesh shield is a flexible mesh shield and the first air-permeable conductive mesh layer is secured at a first conducive mesh layer upper end to the wearable support member to hang from the wearable support member, and the second air-permeable conductive mesh layer is secured at a second conductive mesh layer upper end to the wearable support member to hang from the wearable support member.

The wearable support member may include a resilient support wire and at least one fastener to secure the resilient support wire to a headpiece.

The wearable support member may include a headpiece and the flexible mesh shield may be secured to a rim of the headpiece to hang from the rim.

The headpiece may be a hat and the flexible mesh shield may be secured to a brim of the hat.

The mesh shield may be a mesh enclosure shaped to enclose a user's head when the mesh shield is secured to the hat and the hat is worn by the user.

The personal protective apparatus may further comprise a control system including an on-off toggle governing the supply of power from the portable power supply to the mesh shield.

An edge of the mesh shield may terminate in a non-conductive header.

The personal protective apparatus may further comprise a rigid face shield.

The personal protective apparatus may further comprise a viewing window.

The portable power supply may include a rechargeable power storage device, and the personal protective apparatus may further comprise recharging system coupled to the rechargeable power storage device to join the rechargeable power storage device to an external power supply to be recharged from the external power supply.

The recharging system may include at least one of a non-contact fast charger thin receiver coil and an external recharge contact on a surface of the wearable support member.

The mesh shield may include a second air-permeable non-conductive mesh layer adjacent the second air-permeable conducive mesh layer opposite the first air-permeable non-conductive mesh layer; and a protective mesh layer adjacent the second air-permeable non-conductive mesh layer opposite the second air-permeable conductive mesh layer.

The portable power supply may be operable to charge the mesh shield to apply a current with a high voltage across a droplet or particle bridging the first and second air-permeable non-conductive mesh layers.

According to some aspects, there is provided a personal protective apparatus, comprising a wearable support member; and a flexible mesh shield securable to the wearable support member, the flexible mesh shield shaped for shielding a portion of a user's body, the flexible mesh shield including at least one air-permeable mesh layer, and wherein the at least one air-permeable mesh layer includes at least one of an anti-virus material and an anti-microbial material.

In some examples, the at least one air-permeable mesh layer is securable at a first mesh layer upper end to the wearable support member to hang from the wearable support member.

The wearable support member may be a headpiece.

The wearable support member may be a glove.

The wearable support member may include a back and a cuff of the glove, and a palm of the glove may include the mesh shield.

The at least one air-permeable mesh layer may include copper.

The at least one air-permeable mesh layer may include at least one anti-pathogen mesh layer to assist in sanitizing air, the at least one anti-pathogen mesh layer including at least one of the anti-virus material and the anti-microbial material, and at least one filter layer including a filter material.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of a first personal protective apparatus;

FIG. 2 is a perspective view of a second personal protective apparatus;

FIG. 3 is a perspective exploded and cut away view of the second personal protective apparatus of FIG. 2;

FIG. 4 is an exploded cross sectional view of a portion of the second personal protective apparatus of FIG. 2 taken along line 4-4 of FIG. 3;

FIG. 5 is a perspective view of a third personal protective apparatus;

FIG. 6 is a perspective view of a fourth personal protective apparatus; and

FIG. 7 is a perspective view of a fifth personal protective apparatus;

FIG. 8 is a perspective view of a sixth personal protective apparatus;

FIG. 9 is a perspective view of a seventh personal protective apparatus; and

FIG. 10 is a perspective view of an eighth personal protective apparatus.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or process described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

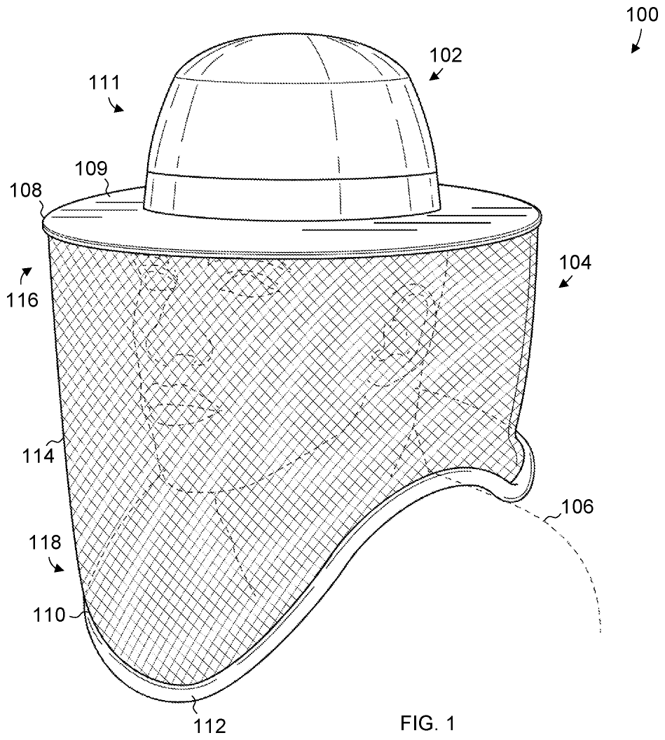

Referring to FIG. 1, an example of a personal protective apparatus 100 is shown. The illustrated personal protective apparatus 100 includes a wearable support member 102 and a mesh shield 104 secured directly or indirectly to the wearable support member 102. The personal protective apparatus 100 is worn by a wearer user 106. The personal protective apparatus 100 may be more comfortable (e.g., more comfortable to wear and/or allowing a freer movement of air in and out) and/or more effective than a filter mask.

The mesh shield 104 may be permanently secured (e.g., glued or thermally welded) or removably secured (e.g., via hook and loop fasteners, magnets, snap-fit fasteners, or threaded fasteners) to the wearable support member 102. Removing the mesh shield 104 may allow the shield to be detached, cleaned (e.g., with standard mild cleaners), and dried more easily.

In some examples, the mesh shield 104 is operable to assist in sanitizing, disinfecting and/or sterilizing air passing through the mesh shield 104. In a first example, the mesh shield 104 may be charged to apply a current having a high voltage through fluid droplets and/or particles suspended in air as the air passes through the mesh shield 104. In a second example, the mesh shield 104 may alternatively or additionally be formed of and/or incorporate a material that assists in sanitizing, disinfecting, and/or sterilizing fluid droplets or particles suspended in air that passes through the mesh shield 104 (e.g., silver or copper).

The mesh shield 104 may be a flexible member, but may also be a stiff member and/or include a stiff portion. The illustrated mesh shield 104 is configured to hang from the brim of the hat, and is similar to a bug mesh in flexibility and appearance. In some examples, as in the illustrated example, the wearer 106 can see through the mesh shield 104.

The personal protective apparatus 100 is shaped to be worn so some of the air inhaled by the wearer passes through the mesh shield 104. In some examples, the personal protective apparatus 100 is shaped to be worn so all or substantially all air inhaled by the wearer passes through the mesh shield 104. For example, the wearable support member 102 and/or the mesh shield 104 and/or the personal protective apparatus 100 may be shaped to be sealingly secured to a wearer's body to inhibit air movement between the wearer's body and the mesh shield 104.

The mesh shield 104 may cooperate with one or more other structures to intercept all or substantially all air inhaled by the wearer. The illustrated mesh shield 104 is sealingly secured to the wearable support member 102 to inhibit air movement between the mesh shield 104 and the wearable support member.

In some examples, the mesh shield 104 and/or an air permeable layer of the mesh shield 104 is secured to the wearable support member 102 to hang in front of the face of the user 106, and may be positioned or positionable in front of a user's face and/or mouth to interact with air being inhaled. In the illustrated example, the wearable support member 102 includes a headpiece, and the mesh shield 104 is secured to the headpiece to hang from the headpiece. In the illustrated example, the mesh shield 104 is a single, flexible air permeable mesh layer 114. The single, flexible air permeable mesh layer 114 is secured at an upper end 116 to the wearable support member 102 to hang from the wearable support member 102.

In the illustrated example of FIG. 1, the mesh shield 104 is a single layer 114. However, in some examples, the mesh shield may include a plurality of layers, one or more of which are formed of at least one of an anti-viral material and an anti-microbial material. For example, a mesh shield may be formed of a plurality of layers of an anti-virus material. One or more layers may be mesh layers with holes small enough for the mesh shield 104 to assist in sanitizing, disinfecting, and/or sterilizing breath aerosols in addition to droplets (e.g., a mesh layer with an average or maximum hole size between 0.3 and 300 μm or between 1 and 200 μm or between 1 and 100 μm). Holes may be small and two or more layers may be staggered, such as to offset the holes of one layer from the holes of another to allowing larger holes to be used while still assisting in sanitizing, disinfecting, and/or sterilizing breath aerosols.

In some examples, a layer of the mesh shield 104 includes or is formed of copper. In some examples, a layer includes or is formed of copper, and the mesh shield 104 also includes at least one additional layer formed of or including a different anti-viral material to enhance the performance of the mesh shield 104.

The mesh shield 104 may be secured directly or indirectly to a rim 108 of the wearable support member 102, such as a laterally outer rim or edge of the headpiece. The illustrated example wearable support member 102 includes a hat, and the rim 108 is provided on a brim 109 of the hat 111. As illustrated in FIG. 1, the mesh shield 104 is secured to the brim to hang from the brim.

The mesh shield 104 may be an annular member. In the illustrated example, the mesh shield 104 is an annular member hanging from an annular brim of a hat. An annular mesh shield 104 may surround the head of a user 106 to treat air moving towards the head of the user 106 from any lateral direction.

A mesh shield edge 110 of the mesh shield 104 may terminate in a header 112. The header 112 may be weighted and/or stiff to facilitate positioning of the mesh shield 104. The illustrated layer 114 is secured at a first layer upper end 116 to the brim 108 of the hat 102 and ends at a lower end 118 in the weighted header 112. In the illustrated example, the header 112 is shaped to drape over the upper body of the user 106 (e.g., over the shoulders, upper chest, and upper back of the user). The header assists in holding the mesh shield 104 in position over the face of the user 106.

As mentioned above, the mesh shield 104 may assist in sanitizing, disinfecting, and/or sterilizing air passing through the mesh shield. The illustrated mesh shield 104 is a single-layer mesh shield which assists in sanitizing, disinfecting, and/or sterilizing air by including at least one of an anti-virus material and an anti-microbial material in the air permeable layer. For example, the mesh shield 104 may include copper, which may act as an anti-virus material. The mesh shield 104 may include multiple mesh layers of copper and/or other anti-virus material to clean and/or sanitize an air-flow.

While the illustrated mesh shield is a single layer mesh shield 104, in some examples the mesh shield 104 includes at least one filter layer in addition to at least one air permeable layer that includes at least one of an anti-virus material and an anti-microbial material. In some examples, the filter layer includes a fibrous filter layer (e.g., a woven or non-woven fibrous filter made of fiberglass, paper, polyester, or cotton fibers which may or may not include an electrostatic charge) and/or a sorbent filter layer (e.g., a layer of activated carbon or activated charcoal). The filter layer may cover an outer surface of the mesh shield 104 to catch at least some particles (e.g., the filter layer may capture all particles larger than and/or have an average or maximum pore size between 0.3 and 10 μm, 0.5 and 10 μm, or 1 and 10 μm) prior to the particles entering the mesh shield. In some examples, the filter layer filters at least 95% of airborne particles from air passing therethrough. In some examples, the filter layer includes an N95 filter sheet material. While the filter layer may facilitate use in dirty environments (e.g., environments with a high level of relatively large particulate matter (e.g., with particles larger than 100 μm or larger than 10 μm), in some examples no filter layer is used (e.g., in a clean environment such as a hospital or in a clean room).

The filter layer may be permanently secured (e.g., glued) or removably secured (e.g., via hook and loop fasteners, magnets, snap-fit fasteners, or threaded fasteners) to the mesh and/or over the mesh (e.g., removably secured to the wearable support member 102 and positioned to hang over the mesh 104). For example, a user may wish to replace a first filter layer with a second or replacement filter layer and may disengage a fastener that is holding the first filter layer to the apparatus 100 to remove the first filter layer from overlaying the mesh 104, and then secure the second filter layer to the apparatus 100 in a position overlaying the mesh 104. Using and/or replacing a filter layer may facilitate use of the apparatus 100 in environments with a high amount of particular matter in the air without requiring as frequent cleaning or replacement of the mesh 104.

The illustrated example personal protective apparatus 100 is operable to assist in sanitizing, disinfecting, and/or sterilizing air inhaled by the wearer 106 by directing the air into close proximity to the copper in the mesh shield 104 to damage viruses carried by the air. However, in some examples, the mesh shield 104 is operable to alternatively or additionally use a current having a high voltage to assist in sanitizing, disinfecting, and/or sterilizing air.

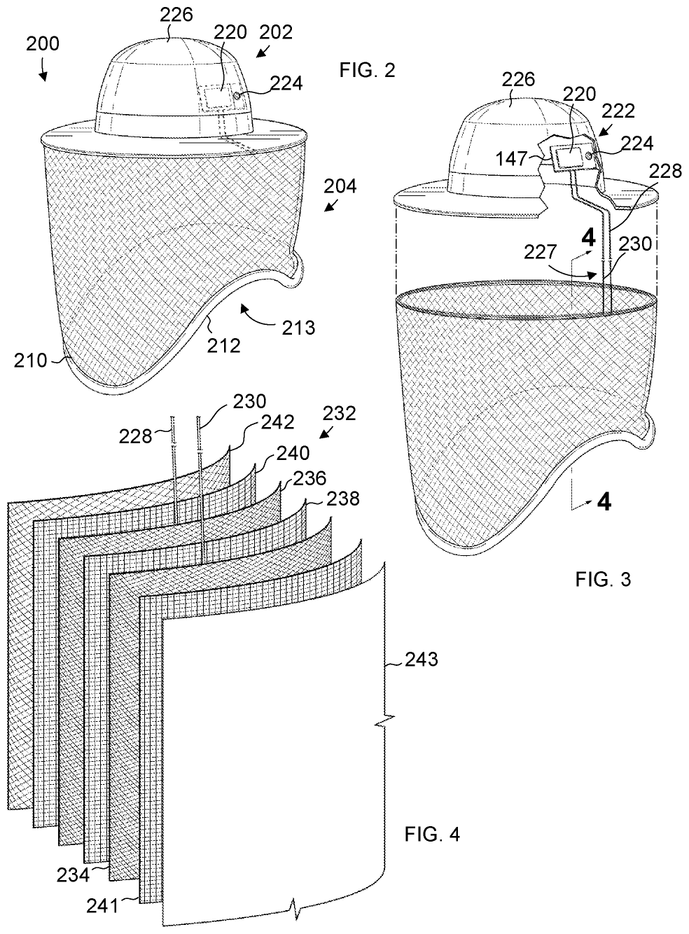

Referring now to FIG. 2, in some examples, a personal protective apparatus 200 is operable to be charged, e.g., to apply a current having a high voltage through fluid droplets or particles suspended in air that passes through the mesh shield. Viruses and bacteria may be very vulnerable to damage when they are in the open (i.e., before entering the body and beginning to replicate), and may be more easily stopped in the open. They may also be passed between people more readily through fluid droplets and may be damaged relatively easily via applying an electric field that deactivates them (e.g., so they cannot replicate afterwards). The fluid droplets in which the bacterial and/or viruses travel may also enhance the effect of electric fields.

Personal protective apparatus 200 is charged. For example, the voltage may be between 40 volts and 100,000 volts. The current may be a low current. For example, the current may be between 0.0004 amps (e.g., with 100,000 volts) and 0.1 amps (e.g., with 40 volts).

The illustrated example personal protective apparatus 200 is similar in some respects to the example personal protective apparatus 100, and like features are indicated by like reference numbers incremented by 100. Similar to personal protective apparatus 100, the personal protective apparatus 200 may also be more comfortable (e.g., more comfortable to wear and/or allowing a freer movement of air in and out) and/or more effective than a filter mask.

The personal protective apparatus 200 includes a portable power supply 220. For example, the portable power supply may be a lithium battery. The portable power supply 220 allows one or more layers of the mesh shield 204 to be powered. The portable power supply 220 is coupled to the mesh shield 204 to provide power to the mesh shield 204.

The mesh shield 204 may be one or more layers, each including at least one of an anti-virus material and an anti-microbial material, similar to the mesh shield 104 of personal protective apparatus 100. However, in some examples, the mesh shield 204 is charged instead of including at least one of an anti-virus and an anti-microbial material. In some examples, the mesh shield 204 is powered in addition to including at least one of an anti-virus and an anti-microbial material. In some examples, the mesh shield 204 includes at least one conductive material that is also at least one of an anti-virus material and an anti-microbial material, such as copper.

The illustrated personal protective apparatus 200 includes a control system 222 to govern the supply of power from the portable power supply 220 to the mesh shield 204.

Referring to FIG. 3, in the illustrated example the control system 222 includes an on-off toggle 224. The on-off toggle 224 is communicatively coupled to the portable power supply 220 to direct the portable power supply 220 to provide or cease providing power to the mesh shield 204.

The on-off toggle 224 may include a wireless communications device to receive a wireless command signal. For example, a mobile device may be used to control the supply of power from the portable power supply 220 to the mesh shield 204. In the illustrated example, the on-off toggle 224 includes a button on an exterior surface 226 of the wearable support member 202 to be physically pressed by a user to control the supply of power from the portable power supply 220 to the mesh shield 204, which may allow for less complicated operation than if a user needs to connect a mobile device. In some examples, both a hard button and a soft button on a mobile application operating on a connected mobile device are available to a user to choose.

The portable power supply 220 is coupled to the mesh shield 204 with one or more high-voltage leads 227. For example, the portable power supply may be coupled to a transformer through a low voltage lead, such as a 1.5 volt lead, and then a high voltage lead may join the transformer to the mesh shield. The illustrated portable power supply 220 is coupled to the mesh shield 204 with a negative high voltage lead 228 and a positive high voltage lead 230.

In some examples, the mesh shield 204 is powered with a voltage and an amperage that will kill at least one of a virus and a bacteria. In some examples, the mesh shield 204 is powered with a voltage below 100 volts (e.g., as low as 40 volts or less). However, in some examples, the mesh shield 204 may be powered with a current (e.g., between 0.0004 amps and 0.1 amps) having a high voltage. For example, the voltage may be between 100 volts and 100,000 volts. In some examples, the mesh shield 204 may be powered similar to an electric fence or an electronic insect-killing swatter. For example, the mesh shield may be powered by a low voltage DC power supply consisting of a plurality of batteries (e.g., a 1.5 volt battery or a plurality of 1.5 volt batteries, such as two, connected in series or parallel), connected to a high voltage generating circuit. The high voltage generating circuit may include a step up transformer configured to be used with a time-varying current. For example, the high voltage generating circuit may be used with a direct current power supply (e.g., batteries such as one or more 1.5 V batteries), and may include a device to provide a time-varying current (e.g., an inverter to convert direct current to alternative current or a oscillator to convert direct current into pulses of current) and the step up transformer to raise the voltage and lower the current passed to the mesh. The high voltage generating circuit may be configured to generate a high voltage of at least 1,000 volts.

In some examples, the high voltage is at least 2,000 volts. In some examples, the high voltage is at least 50,000 volts. In some examples, the portable power supply 220 may be one or more batteries, such as 1.5 volt batteries, connected in series or parallel and providing a current to the mesh shield 204 that is stepped up to at least 1,000 volts using an oscillating circuit and a transformer. For example, as mentioned above, the voltage may be between 40 volts and 100,000 volts.

The power may be supplied (e.g., by the control system 222) as a direct current, or as a pulsed direct current or alternating current. In some examples, a user may select the power output (e.g., via a hard button(s) or switch(s) on the apparatus or via a soft button(s) on a mobile application running on a mobile device such as a smartphone or tablet).

In some examples, the wearable support member 202 may include a solar panel that is coupled to a battery of the personal protective apparatus 200 to charge the battery.

The high voltage leads may be part of the control system 222. The control system 222 may also include a transformer to step up the voltage between the portable power supply 220 and the mesh shield 204.

In some examples, the control system also includes a logic board. The control system 222 may be operable to automatically shut off power to the mesh shield 204 in the case of predefined conditions (e.g., in response to a detected change in resistance). For example, the control system 222 may be able to automatically shut off power to the mesh shield 204 if the mesh shield becomes wet due to falling into water or due to rain. The control system 222 may include a circuit breaker that can be reset. For example, the control system 222 may include a circuit breaker similar to one or more of a ground fault circuit interrupter (GFCI) circuit breaker and an arc-fault circuit interrupter (AFCI) circuit breaker. A circuit breaker may allow enough energy to kill and/or inactivate a virus and/or bacteria, but trip open when a larger load is sensed, such as water or rain or physical damage to the mesh shield 204 causing a short between conductive layers.

In some examples, when the control system 222 senses a first volume of water in contact with the mesh, the circuitry adjusts the voltage in the mesh to a higher voltage (e.g., above 100,000 volts) and lower current. Alternatively, or in response to sensing a second volume of water that is greater than the first volume of water, the control system 222 may shut off the power to the mesh.

The control system 222 may also include a notification device, such as a light or speaker that can alert a user to a status of the personal protective apparatus 200. For example, the control system 222 may include a light emitting diode on the exterior surface 226 of the wearable support member 202. The light emitting diode may show a functional status by use of a first color for a standard status and one or more further colors for a fault status or other conditional status.

A notification device may be used to alert a user to a need to clean the personal protective apparatus 200, and the user may be able to turn off and remove the personal protective apparatus 200 for cleaning and/or sanitizing. When a personal protective apparatus 200 has been cleaned and/or sanitized and/or dried, it can be reset and reused.

Referring to FIG. 4, the mesh shield 204 includes a plurality of layers 232. The plurality of layers 232 includes a first air-permeable conductive layer 234, a second air-permeable conductive layer 236, and a first air-permeable non-conductive layer 238 received between first air-permeable conductive layer 234 and the second air-permeable conductive layer 236 to separate the first air-permeable conductive layer 234 and the second air-permeable conductive layer 236. The layers may be mesh layers. In the illustrated example, the first and second air-permeable conductive layers 234 are each mesh layers and may be formed of a conductive material.

The conductive layers may be formed of a flexible conductive material, such as or including metal woven into fabric. For example, a conductive layer may include an electromagnetic shielding fabric. The non-conductive layer may include a flexible plastic film material.

The portable power supply 220 is coupled to the mesh shield 204 with the negative high voltage lead 228 to the first air-permeable conductive layer 234 and the positive high voltage lead 230 to the second air-permeable conductive layer 236, and is operable to charge the first air-permeable conductive layer 234 and second air-permeable conductive layer 236.

The first air-permeable non-conductive layer separates the first air-permeable conductive layer 234 and the second air-permeable conductive layer 236. The first air-permeable conductive layer 234 and the second air-permeable conductive layer 236 may be conductively joined to each other when a fluid droplet or particle is between the first air-permeable conductive layer 234 and the second air-permeable conductive layer 236. A fluid droplet or particle conductively joining the first air-permeable conductive layer 234 and the second air-permeable conductive layer 236 may be subject to a current having a high voltage when the conductive layers 234, 236 are charged. The current having the high voltage may be sufficient to kill contaminants such as pathogens such as viruses and/or bacteria.

The mesh shield 204 may be a flexible mesh shield which includes one or more flexible layers each including a plurality of holes to allow for air flow therethrough. The holes of a non-conductive layer may be larger than the holes of a conductive layer, so that the non-conductivity layer separates conductive layers without obstructing air flow.

Holes in the conductive layer may be small enough for the mesh shield 204 to assist in sanitizing, disinfecting, and/or sterilizing breath aerosols in addition to droplets. Holes in the conductive layers may be small and two or more conductive layers may be staggered, such as to offset the holes of one layer from the holes of another to allowing larger perforation holes to be used while still assisting in sanitizing, disinfecting, and/or sterilizing breath aerosols.

In some examples, as in the illustrated example, the mesh shield 204 also includes a second air-permeable non-conductive layer 240 across the conductive layer 236 from the first air-permeable non-conductive layer 238 and/or a third air-permeable non-conductive layer 241 across the conductive layer 238 from the first air-permeable non-conductive layer 238. The second air-permeable non-conductive layer 240 is on an inner side of the mesh shield 204, and may be provided to space the conductive layers from the user. The third air-permeable non-conductive layer 241 is on an outer side of the mesh shield 204, and may be provided to protect the mesh from wear and tear and/or to separate the conductive layers from other people and objects.

The illustrated example mesh shield 204 also includes a reinforcing layer 242 adjacent the second air-permeable non-conductive layer 240 opposite the second air-permeable conductive layer 236. The reinforcing layer is provided to protect the second air-permeable non-conductive layer 240 from harm. For example, the second air-permeable non-conductive layer 240 may be a delicate layer of plastic film that is easily damaged. In some examples, one or more further non-conductive layers may be incorporated, such as a non-conductive outer layer over the first air-permeable conductive layer 234 opposite the first air-permeable non-conductive layer 238 to protect other individuals nearby the user 106.

The reinforcing layer 242 may include similar materials and/or construction as the first air-permeable conductive layer 234 and the second air-permeable conductive layer 236 (e.g., may be formed of a metal), although the reinforcing layer 242 may also include different materials from a conductive layer (e.g., may be formed of a plastic or fabric).

In some examples, the mesh shield 204 includes at least one filter layer 243. In some examples the filter layer 243 includes a fibrous filter layer (e.g., a woven or non-woven fibrous filter made of fiberglass, paper, polyester, or cotton fibers which may or may not include an electrostatic charge) and/or a sorbent filter layer (e.g., a layer of activated carbon or activated charcoal). The filter layer 243 may cover an outer surface of the mesh shield 104 (e.g., covering the outer surface of first air-permeable conductive layer 234) to catch at least some particles (e.g., the filter layer may capture all particles larger than and/or have an average or maximum pore size between 0.3 and 10 μm, 0.5 and 10 μm, or 1 and 10 μm) prior to the particles entering the mesh shield. For example, a filter layer 243 may cover the first conductive layer 234 as illustrated in FIG. 4 (in some examples, one or more further layers such as insulating or reinforcing layers may be between the filter layer 243 and the conductive layer 234, rather than the filter layer 243 directly covering the conductive layer 234 as shown). The filter layer may filter at least 95% of airborne particles from air passing therethrough, and may include a N95 filter sheet material. In some examples, the reinforcing layer 242 may also or alternatively include a filter layer. While the filter layer may facilitate use in dirty environments (e.g., environments with a high level of relatively large particulate matter (e.g., with particles larger than 100 μm or larger than 10 μm), in some examples no filter layer is used (e.g., in a clean environment such as a hospital or in a clean room).

The filter layer may be permanently secured (e.g., glued) or removably secured (e.g., via hook and loop fasteners, magnets, snap-fit fasteners, or threaded fasteners) to the mesh and/or over the mesh (e.g., removably secured to the wearable support member 202 and positioned to hang over the mesh 204). For example, a user may wish to replace a first filter layer with a second or replacement filter layer and may disengage a fastener that is holding the first filter layer to the apparatus 200 to remove the first filter layer from overlaying the mesh 204, and then secure the second filter layer to the apparatus 200 in a position overlaying the mesh 204. Using and/or replacing a filter layer may facilitate use of the apparatus 200 in environments with a high amount of particular matter in the air without requiring as frequent cleaning or replacement of the mesh 204. The filter layer may be formed as a thin sheet (e.g., a sheet of fibrous material and/or sorbent material) and/or a cartridge (e.g., a cartridge that includes activated carbon and/or a fibrous filter such as a pleated filter).

The mesh shield edge 210 of the mesh shield 204 terminates in a header 212. The header 212 is weighted to facilitate positioning of the mesh shield 204, and is shaped to drape over the upper body of the user (e.g., to provide a virtual seal to the body or outer clothing of the user to prevent a flow of untreated air bypassing the mesh). The header may assist in holding the mesh shield 204 in position over the face of the user. The header 212 may be non-conductive.

In some examples, the mesh shield edge 210 and/or header 212 is configured to be gathered together. For example, a neck or chest of the user may extend through the lower opening 213 of the apparatus, and the header 212 may be drawn closed against the neck or chest of the user. In some examples, the edge 210 and/or header 212 includes a drawstring to gather the edge 210 and/or header 212 together. The edge 210 and/or header 212 may be gathered together to form a collar around the user's neck. Gathering the edge 210 and/or header 212 together may keep the mesh from getting in the way of regular movements while still inhibiting air from bypassing the mesh.

Referring again to FIG. 3, in some examples the portable power supply 220 includes a rechargeable power storage device. A recharging system may be is coupled to the rechargeable power storage device to join the rechargeable power storage device to an external power supply to be recharged from the external power supply.

The recharging system may include a non-contact charger. For example, the personal protective apparatus 200 may include a non-contact fast charger thin receiver coil to be charged by proximity to a charging plate. However, the recharging system may include one or more external recharge contacts on a surface of the wearable support member. For example, the personal protective apparatus 200 may include a pair of external contacts on the exterior surface 226 of the wearable support member 202.

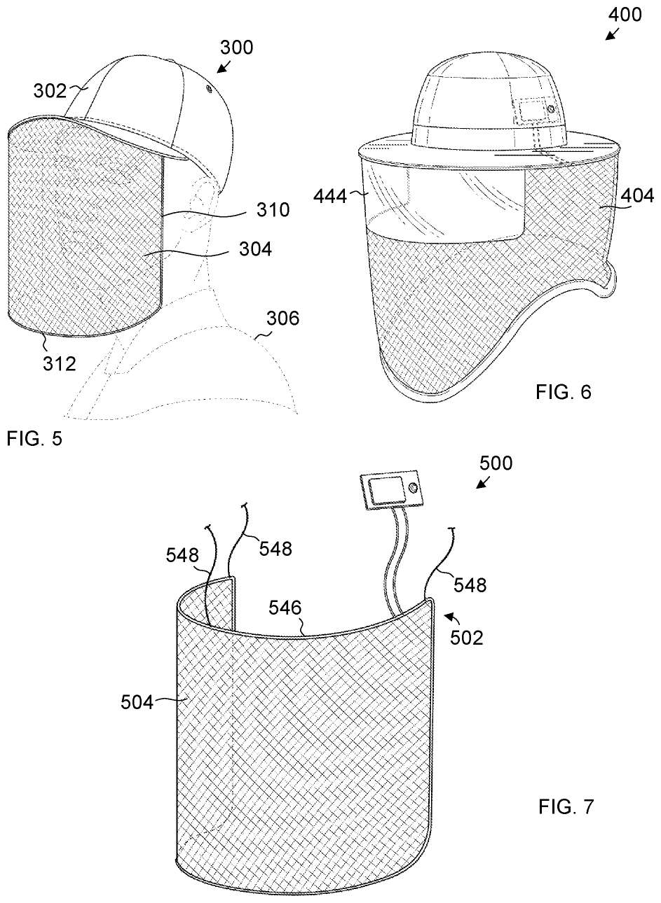

Referring now to FIG. 5, in some examples a personal protective apparatus 300 is not shaped to sealingly engage with a body of a wearer. The illustrated example personal protective apparatus 300 is similar in many respects to the example personal protective apparatus 200, and like features are indicated by like reference numbers incremented by 100.

In the illustrated example, the personal protective apparatus 300 includes a non-annular mesh shield 304 hanging from a wearable support member 302. A weighted and/or stiff header 312 along an edge 310 assists in holding the mesh shield 304 in position. However, the illustrated example personal protective apparatus 300 is open at the bottom and sides and is only shaped so that some of the air inhaled by wearer 306 passes through the mesh shield 304.

Incorporating the mesh shield 304 into a personal protective apparatus that can be sealed against a body of the wearer, such as a mask or hood, may provide greater protection. However, having the personal protective apparatus 300 open in some directions may allow for a simpler design, easier use, and/or easier cleaning.

The illustrated example mesh shield 304 hangs before the face of the user 306, but does not encircle the head of the user. In the illustrated example, the mesh shield hangs from an edge of a bill of a baseball cap to hang in front of the face of the user.

The mesh shield 304 may include a conductive material and be operable to apply a high voltage similar to mesh shield 204, however it may also or alternatively be a single or multi-layered member which includes an anti-viral and/or anti-bacterial material.

Referring to FIG. 6, in some examples a personal protective apparatus 400 includes a rigid face shield 444. The illustrated example personal protective apparatus 400 is similar in many respects to the example personal protective apparatus 200, and like features are indicated by like reference numbers incremented by 200.

The rigid face shield 444 may be a rigidified portion of the mesh shield 404 or a separate member fitted into a hole, slot, or allowance in the mesh shield 404. The personal protective apparatus 400 may be a flexible mesh shield 404 having or cooperating with a rigid face shield or face shield portion. A rigid face shield 444 may be provided to facilitate use. For example, a rigid face shield 444 may allow a user a greater range of movement without the mesh shield 404 impacting the user's face or falling towards something the user is working on.

The personal protective apparatus 404 may also or alternatively include a viewing window, such as to facilitate easier viewing by a user past and/or through the mesh shield 404. In the illustrated example, the rigid face shield 444 is a separate member formed of a transparent material and also forms a viewing window. In the illustrated example, the rigid face shield 444 is formed of a transparent, rigid plastic.

The mesh shield 404 may include a conductive material and be operable to apply a high voltage similar to mesh shield 204, however it may also or alternatively be a single or multi-layered member which includes an anti-viral and/or anti-bacterial material.

Referring to FIG. 7, in some examples a personal protective apparatus 500 includes a wearable support member 502 to be secured to a headpiece. The illustrated example personal protective apparatus 500 is similar in many respects to the example personal protective apparatus 200, and like features are indicated by like reference numbers incremented by 300.

The wearable support member 502 includes a rigid and/or resilient member to sealingly engage the headpiece to inhibit air movement between the wearable support member 502 and the headpiece. The illustrated wearable support member 502 includes a resilient support wire 546 and at least one fastener 548.

The wearable support member 502 is to be secured to a headpiece such as a hat, and a plurality of fasteners 548 are provided to secure the resilient support wire to the headpiece. The illustrated fasteners 548 are tie fasteners, but in other examples other fasteners may be used such as magnetic, adhesive, or threaded fasteners.

The mesh shield 504 may include a conductive material and be operable to apply a high voltage similar to mesh shield 204, however it may also or alternatively be a single or multi-layered member which includes an anti-viral and/or anti-bacterial material.

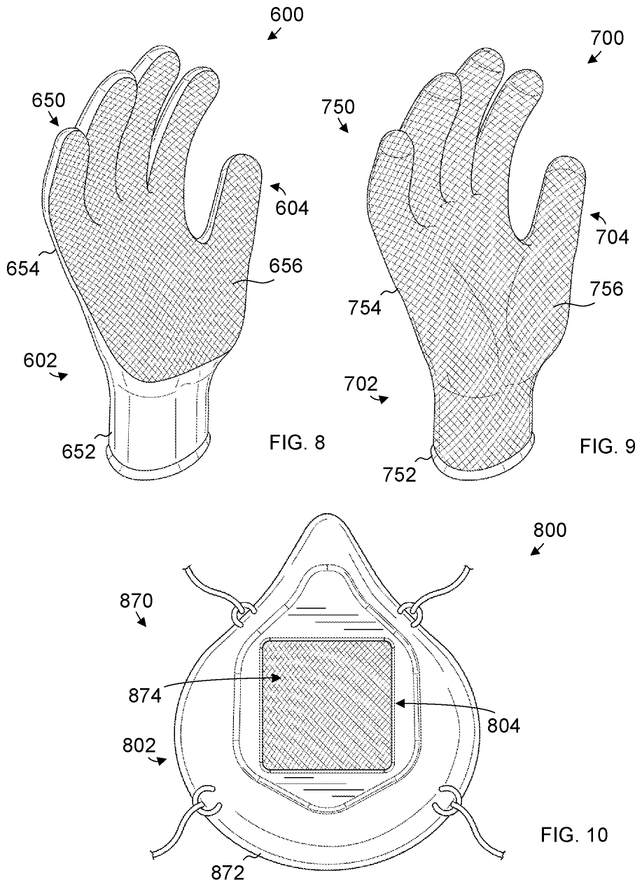

Referring to FIG. 8, in some examples a personal protective apparatus 600 includes a wearable support member 602 that is not a headpiece or to be secured to a headpiece. The illustrated example personal protective apparatus 600 is similar in some respects to the example personal protective apparatus 200 (e.g., similar in the use of a powered mesh and wearable support member), and like features are indicated by like reference numbers incremented by 400.

The illustrated personal protective apparatus 600 includes a glove 650. The wearable support member 602 may be simply a cuff 652 of the glove 650 with the mesh shield 604 forming the body of the glove. However, a wearable support member 602 may include a back 654 and a cuff 652 of the glove 650, with a palm 656 of the glove 650 including the mesh shield 604.

In some examples, the mesh shield 604 overlays the wearable support member 602 or partially overlays the wearable support member 602. For example, the wearable support member 602 may be a full glove, and the mesh shield 604 may be applied over the full glove 650.

The mesh shield 604 may include a conductive material and be operable to apply a high voltage similar to mesh shield 204, however it may also or alternatively be a single or multi-layered member which includes a non-powered anti-viral and/or anti-bacterial material. Where the mesh is powered, the mesh of a glove may, in some examples, operate on a lower overall power setting (e.g., lower voltage and/or current, such as less than 50,000 volts or less than 0.05 amps) than non-glove (e.g., mask or face shield) apparatus (e.g., since the glove is more likely to come into contact with water or liquid). For example, a portable power supply and control system may be provided in the cuff 652 of the glove 650, and the personal protective apparatus 600 may include a small battery, transformer, and logic board.

One or more non-conductive layers may be between the user and any conductive material. For example, the mesh shield 604 across the palm 656 may include at least first and second conductive mesh layers spaced by a non-conductive layer, and at least one non-conductive mesh layer inside the conducive layers.

Referring to FIG. 9, in some examples a personal protective apparatus 700 is a glove 750 with a mesh shield 704 covering a palm 756 and back 754 of the glove 750, the wearable support member 702 is a cuff 752 and/or underlays the mesh shield 704.

The illustrated example personal protective apparatus 700 is similar in some respects to the example personal protective apparatus 200 (e.g., similar in the use of a powered mesh and wearable support member), and like features are indicated by like reference numbers incremented by 500.

The mesh shield 704 may include a conductive material and be operable to apply a high voltage similar to mesh shield 204, however it may also or alternatively be a single or multi-layered member which includes an anti-viral and/or anti-bacterial material.

Referring to FIG. 10, in some examples a personal protective apparatus 800 includes a mask 870. FIG. 10 depicts the mask 870 from directly in front of the mask 870. The illustrated example personal protective apparatus 800 is similar in some respects to the example personal protective apparatus 200 (e.g., similar in the use of a powered mesh and wearable support member), and like features are indicated by like reference numbers incremented by 600.

The mask 870 includes a mesh shield 804 secured to a wearable support member 802. In the illustrated example, the wearable support member 802 is a body portion 872 of a face mask shaped to cover a mouth and nose of a user. The illustrated example mesh shield 804 is received in an aperture 874 through the body portion 872.

The body portion 872 may be sealable against a face of the user to inhibit air movement between the body portion 872 and the face of the user. The body portion may be non-permeable to direct airflow through the aperture 874 and the mesh shield 804. As discussed above, a filter layer (e.g., a fibrous filter layer and/or a sorbent layer) may be used with the mash shield 804. The filter layer may be secured (e.g., removably secured) to the mesh shield 804 and/or the wearable support member 802. For example, the filter layer may be a cartridge (e.g., a cartridge containing charcoal) that can be secured to the body portion 872 in a position covering the aperture 874 upstream of the mesh 804.

In some examples, a wearable support member 802 may be 3D printed. For example, the wearable support member 802 may be a 3D printed mask to cover the nose and mouth of a user without covering the user's eyes.

The mesh shield 804 may include a conductive material and be operable to apply a high voltage similar to mesh shield 204, however it may also or alternatively be a single or multi-layered member which includes an anti-viral and/or anti-bacterial material.

While the above description provides examples of one or more apparatus, methods, or systems, it will be appreciated that other apparatus, methods, or systems may be within the scope of the claims as interpreted by one of skill in the art.

1. A personal protective apparatus, comprising:
a wearable support member;
a mesh shield securable to the wearable support member, the mesh shield being shaped for shielding a portion of a user's body, the mesh shield comprising:
a first air-permeable conductive mesh layer made of an electrically conductive mesh material,
a second air-permeable conductive mesh layer made of an electrically conductive material, and
a first air-permeable non-conductive mesh layer made of a non-conductive material, received between the first and second air-permeable conductive layers to separate the first and second air-permeable conductive layers; and
a portable power supply coupled to the mesh shield with a negative voltage lead connected to the first air-permeable conductive mesh layer and a positive voltage lead connected to the second air-permeable conductive mesh layer.

2. The personal protective apparatus of claim 1, wherein the mesh shield is a flexible mesh shield and wherein:
the first air-permeable conductive mesh layer is secured at a first conducive mesh layer upper end to the wearable support member to hang from the wearable support member, and
the second air-permeable conductive mesh layer is secured at a second conductive mesh layer upper end to the wearable support member to hang from the wearable support member.

3. The personal protective apparatus of claim 2, wherein the wearable support member includes a resilient support wire and at least one fastener to secure the resilient support wire to a headpiece.

4. The personal protective apparatus of claim 2, wherein the wearable support member includes a headpiece and the flexible mesh shield is secured to a rim of the headpiece to hang from the rim.

5. The personal protective apparatus of claim 4, wherein the headpiece is a hat and the flexible mesh shield is secured to a brim of the hat.

6. The personal protective apparatus of claim 4, wherein the mesh shield is a mesh enclosure shaped to enclose a user's head when the mesh shield is secured to the hat and the hat is worn by the user.

7. The personal protective apparatus of claim 1, further comprising a control system including an on-off toggle governing the supply of power from the portable power supply to the mesh shield.

8. The personal protective apparatus of claim 1, wherein an edge of the mesh shield terminates in a non-conductive header.

9. The personal protective apparatus of claim 1, further comprising a rigid face shield.

10. The personal protective apparatus of claim 1, further comprising a viewing window.

11. The personal protective apparatus of claim 1, wherein the portable power supply includes a rechargeable power storage device, and the personal protective apparatus further comprises recharging system coupled to the rechargeable power storage device to join the rechargeable power storage device to an external power supply to be recharged from the external power supply.

12. The personal protective apparatus of claim 11, wherein the recharging system includes at least one of a non-contact fast charger thin receiver coil and an external recharge contact on a surface of the wearable support member.

13. The personal protective apparatus of claim 1, wherein the mesh shield further includes:
a second air-permeable non-conductive mesh layer adjacent the second air-permeable conducive mesh layer opposite the first air-permeable non-conductive mesh layer; and
a protective mesh layer adjacent the second air-permeable non-conductive mesh layer opposite the second air-permeable conductive mesh layer.

14. The personal protective apparatus of claim 1, wherein the portable power supply is operable to charge the mesh shield to apply a current with a high voltage across a droplet or particle bridging the first and second air-permeable non-conductive mesh layers.

15. A personal protective apparatus, comprising:
a wearable support member; and
a flexible mesh shield securable to the wearable support member, the flexible mesh shield shaped for shielding a portion of a user's body, the flexible mesh shield including at least one air-permeable mesh layer, and
wherein the at least one air-permeable mesh layer includes at least one of an anti-virus material and an anti-microbial material.

16. The personal protective apparatus of claim 15, wherein the at least one air-permeable mesh layer is securable at a first mesh layer upper end to the wearable support member to hang from the wearable support member.

17. The personal protective apparatus of claim 16, wherein the wearable support member is a headpiece.

18. The personal protective apparatus of claim 15, wherein the wearable support member is a glove.

19. The personal protective apparatus of claim 18, wherein the wearable support member includes a back and a cuff of the glove, and wherein a palm of the glove includes the mesh shield.

20. The personal protective apparatus of claim 15, wherein the at least one air-permeable mesh layer includes copper.

21. The personal protective apparatus of claim 15, wherein the at least one air-permeable mesh layer includes:
at least one anti-pathogen mesh layer to assist in sanitizing air, the at least one anti-pathogen mesh layer including at least one of the anti-virus material and the anti-microbial material, and
at least one filter layer including a filter material.
